(19) United States
(12) Patent Application Publication
(10) Pub. No.: US 2004/0044822 A1
(43) Pub. Date: Mar. 4, 2004

(54) Computer I/O switching means based on network links

(76) Inventor: Heng-Chien Chen, Taipei (TW)

Correspondence Address: DELLETT AND WALTERS, 310 S.W. FOURTH AVENUE, SUITE 1101, PORTLAND, OR, 97204, US

(21) Appl. No.: 10/234,495

(22) Filed: Sep. 3, 2002

(51) Int. Cl. G06F 13/00

(52) U.S. Cl. 710/312

(57) ABSTRACT

A computer I/O switching means interfacing between multiple I/O devices and host computers under a network structure, comprising a central switch, multiple bridges, which are to be linked to multiple sets of host computer through network cables, and a network interface. The central switch is set up with multiple I/O interfaces for keyboard, video display and mouse, and multiple bridges are each electronically connected to the respective computers in the centralized computer facility. The central switch also provides a menu-based control program, which allows users to lock in a specific host computer for input/output operation through the corresponding bridge. The switching means employing networking technology helps cut down related cabling costs considerably, and simplify the equipment configuration.

### BACKGROUND OF THE INVENTION

1. Field of the Invention

The present invention relates to a computer I/O switching means interfacing between computer I/O devices and multiple host computers based on network links, whereby related cabling for multiple I/O devices can be considerably reduced, and the equipment configuration in the centralized computer facility can be much simplified under a network structure. This computer I/O switching means can be used on all computers and I/O devices as long as their interface is compatible with the standard specifications, and the connection distance for remote host can also be further extended using network technology.

2. Description of Related Arts

At the present time, many companies and factories have multiple sets of host computer installed in a centralized location known as the computer room. To simplify the operation control and equipment configuration, a KVM switch (literally standing for keyboard (K), video (V) and mouse (M)) is normally used for interfacing between multiple I/O devices and host computers running concurrently. Basically a KVM switch is capable of providing network support and I/O resource management, through which I/O can be established and control instructions can be input with regard to a selected host computer, and data can also be retrieved therefrom. Technically speaking, only one set of I/O devices is needed through the service of KVM switch for controlling the concurrent operation on multiple host computers or retrieving data therefrom.

FIG. 5 shows the equipment configuration using a conventional KVM switch (50) interposing between a set of I/O devices and multiple host computers in a centralized computer facility (60). A conventional KVM switch (50) could be operated by either mechanical or electronic means, which normally provides four connecting ports (54) for connecting to host computers (60), could be more with eight or twelve connecting ports (54), through which each is linked to a corresponding host computer (60). Since the KVM switch (50) supports standard I/O devices such as video display (51), for example VGA, mouse (52), and keyboard (53). Since the signal transmission specification for these three devices are not the same, at least three kinds of signal interface would be needed for building a system configuration. In this case, if there were many host computers (60) in the computer facility, the cabling and system connections for interconnecting all I/O devices and host computers could be increased by multifold in relation to the number of host computers. The problems of signal propagation delays could also be a problem, especially for VGA display. If over-stretching the video cable, the resultant video output on screen would be greatly affected.

Since most KVM switches (50) currently available have limited number of connecting ports (54) for various I/O devices. For establishing an I/O resource pool for a multi-computer system, multiple switches have to be cascaded in order to interconnect a variety of I/O devices, and the related cabling in the centralized computer facility could be very complicated and costly.

From the foregoing, there can be many drawbacks using the conventional KVM switch, such as:

1. Limited connection ports: unable to satisfy great variety of I/O devices and host computers;

2. Hardware solution only: the wears and tears for the switching device cannot be underestimated;

3. Massive cabling needed for interconnecting all I/O devices and host computers, and difficulty to control; and

4. Difficult to maintain stable performance for remote hosts due to propagation delay and signal attenuation over long distance.

### SUMMARY OF THE INVENTION

The main object of the present invention is to provide a computer I/O switching means interfacing between multiple sets of I/O devices and host computers, that enables the sharing of I/O resources and cutting down of related cabling and number of system connections.

The proposed computer I/O switching means comprises a central switch and multiple bridges.

The central switch comprises a controller, at least one set of I/O interface with different specifications for corresponding video display, keyboard and mouse, and a network interface.

The bridge comprises a controller, multiple I/O ports to be linked with corresponding I/O ports on a host computer, and a network interface.

The controller for either the central switch or bridges is mainly used for processing digital signals and packing signals into network packets for transfer over network link.

The network interface of the central switch is connected to the counterpart in the bridges through a network link.

The above mentioned computer I/O switching means is linked under a network architecture, enabling sharing of I/O devices and cutting down the use of connecting cables considerably. The central switch is installed with a menu-based control program, which can direct input to or conversely or output from a host computer through a specific bridge, whereby the central switch can lock into a specific host computer for control operation and data retrieval. The controller of the central switch and the counterpart in the bridges communicate by means of network packets, thus reliable signal transmission can be maintained between host computers and the pool of I/O devices in a network configuration.

From the above description, it is clear that a single network cable is needed to interconnect a host computer, eliminating various cables with different I/O specifications, thus related cabling costs can be cut down considerably and the equipment configuration can be simplified.

The secondary objective of the present invention is to provide an I/O switching means that is technically capable of supporting large numbers of host computer up to several hundred units through network links.

Since data is transferred in the form of network packets, noise and signal propagation delays can be kept to a minimum, and the connection distance can be further extended using network technology. Technically, one computer I/O switching means is enough to support up large numbers of host computers installed in a centralized location.

The features and structure of the present invention will be more clearly understood when taken in conjunction with the accompanying figures.

### BRIEF DESCRIPTION OF THE DRAWINGS

FIG. 1 is a computer I/O switching means supporting multiple host computers in accordance with the present invention;

FIG. 2 is a block diagram of the preferred embodiment of the invention, showing a computer I/O switching means interfacing between one set of I/O devices and multiple host computers through network links;

FIG. 3 is a block diagram of another preferred embodiment of the invention, showing a more complicated computer I/O switching means interfacing between two sets of I/O devices and multiple host computers through network links;

FIG. 4 is a block diagram of the internal structure of a bridge in accordance with the invention;

FIG. 5 is the system configuration of various I/O devices and host computers controlled by a conventional KVM.

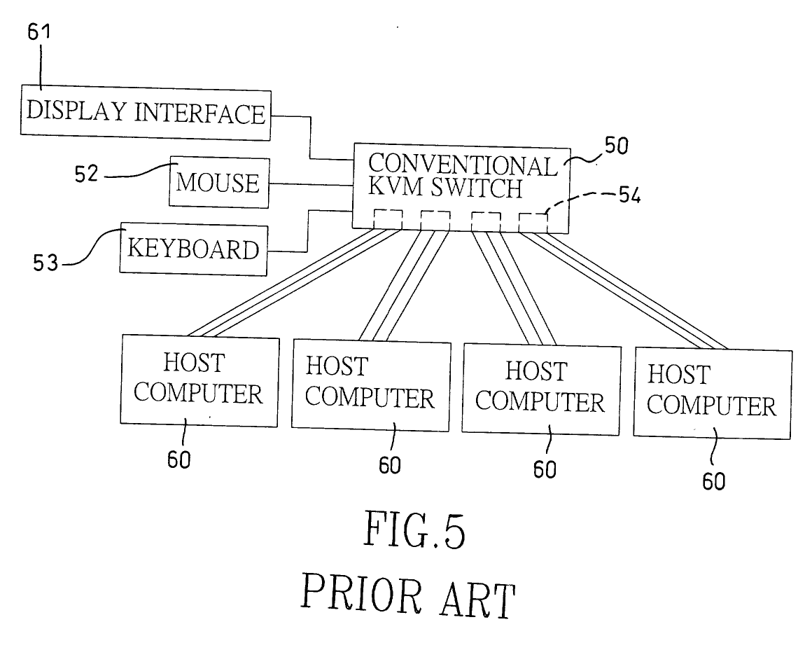

### DETAILED DESCRIPTION OF THE PREFERRED EMBODIMENT

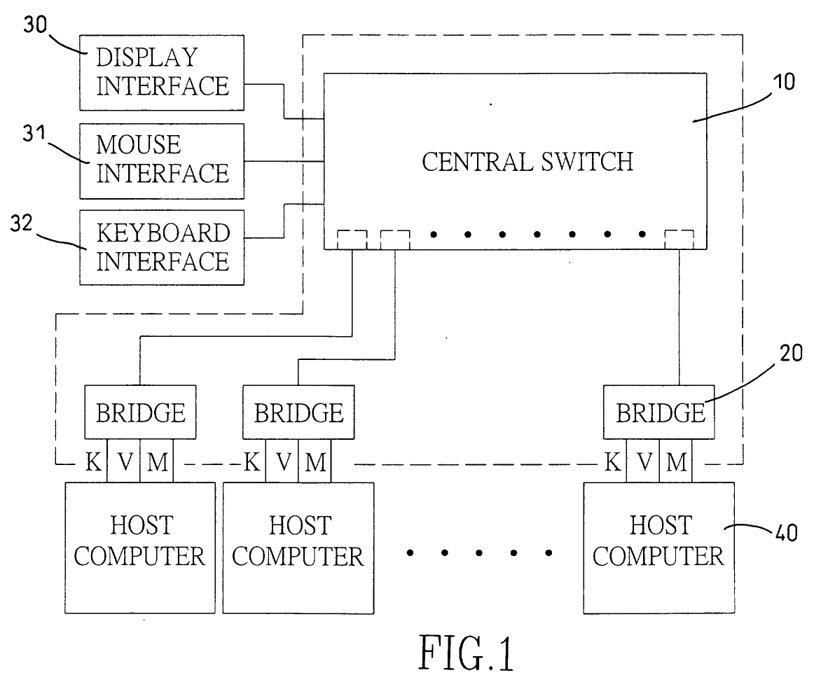

FIG. 1 shows a multi-computer system configuration using a computer I/O switching means in accordance with the present invention. The computer I/O switching means interposing between a set of computer I/O devices and multiple host computers which enables the sharing of I/O resources and cutting down of related cabling and system connections considerably.

The proposed computer I/O switching means comprises a central switch (10), and multiple bridges with network interface (20).

The central switch (10) includes a controller (11) and at least one set of signal I/O interface (12) with different specifications for I/O devices such as video display, keyboard and mouse, and multiple network interface (13).

The controller (11) in the central switch (10) is responsible for processing digital I/O signals and putting them into network packets for transfer over a network. The controller (11) is also installed with a menu-based control program, whereby users can direct I/O to a host computer through a specific bridge

The I/O interface (12) contains one set of I/O ports (in the current embodiment) for linking various I/O devices under the control of the controller (11). These I/O devices could be video display (30), mouse (31), and keyboard (32). The communication between the controller (11) and the I/O interface (12) is conducted in a digital manner.

The network interface (13) controlled by the controller (11) is connected to other network components through a network, using network packets to transmit and receive signals.

The controller (11) has installed with a menu-based control program, which can be output onto a computer screen, allowing users to direct I/O to a host computer through a specific bridge on network links.

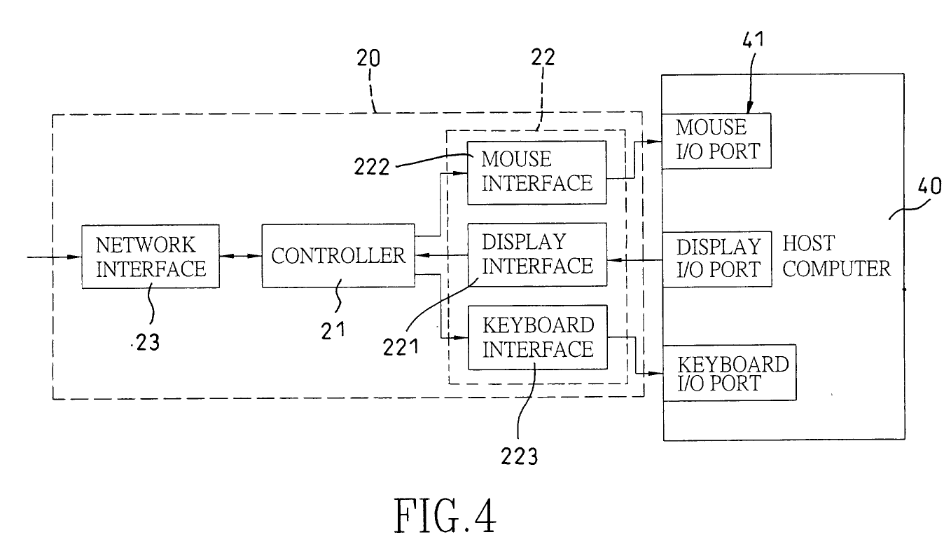

FIG. 4 is a block diagram of the internal structure of a bridge (20) in accordance with the invention. Each bridge (20) is formed by a controller (21), a set of I/O interface (22) which is linked to corresponding I/O ports on a host computer (40), and a network interface (23), wherein each bridge (20) is electronically connected to a host computer (40).

The controller (21) is responsible for processing digital signals and converting them to network packets for transfer over a network.

The network interface (23) regulated by the controller (21) is used for interconnecting other network components on the network. The network interface (23) passes the network packets from the controller (21) over the network, or conversely receives network packets over the network and passes on to the controller (21).

The set of I/O interface (22) is respectively connected to various I/O ports (41) on a host computer (40), which are compatible with the standard specifications for video display (221), mouse (222) and keyboard (223). The data communication between the controller (21) and I/O interface (22) are carried out in a digital manner.

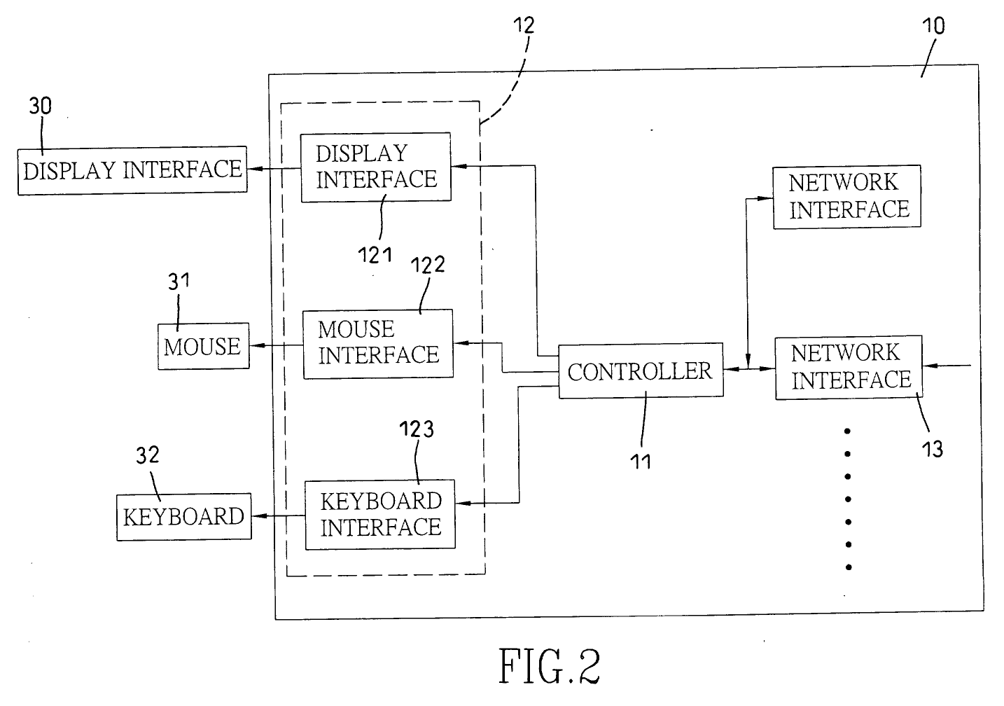

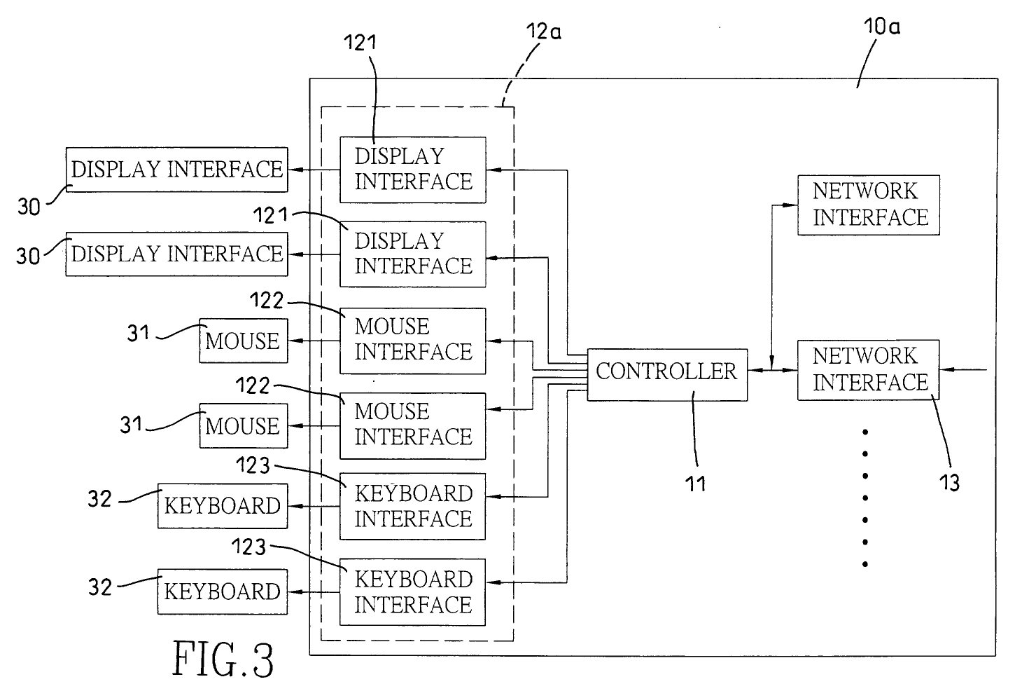

FIGS. 2 and 3 are block diagrams of preferred embodiments of the invention, in which the computer I/O switching means interfacing between one set of I/O devices and multiple host computers through bridges, and in a more complicated case, the I/O switching means (10a) in FIG. 3 interfaces between more than one set of I/O devices and multiple host computers (40) through network links The computer I/O switching means (10a) controls the actions of I/O devices through a central switch under network architecture. The network topology could be in the form of a star, a bus, or a ring. The present I/O switching means employing network technology could cut down on related cabling requirements and system connections.

The built-in menu-based control program stored in the central switch allows users to direct input to a host computer through a specific bridge. With such software control for I/O switching, various I/O resources can be shared by multiple host computers, thus cut down on cabling and system connection costs considerably.

The software controlled switching means enables a user to lock into a specific host computer for controlling internal operation and retrieving data therefrom. The central switch (10) and the controller (11) in the bridges communicate by packets, ensuring reliable signal transmission between the host computer and I/O devices in a network architecture.

From the foregoing, it is clear that the computer I/O switching means under the network configuration is more advantageous as compared with the conventional KVM switch, in that:

1. Possible to support up to several hundred sets of host computers concurrently;

2. Reduced cabling and system connections considerably;

3. Connection distance for remote host computer can be further extended using networking technology;

4. Easier management of I/O devices by means of a software control program; and

5. Linking multiple sets of I/O devices with multiple host computers at the same time.

The foregoing description of the preferred embodiments of the present invention is intended to be illustrative only and, under no circumstances, should the scope of the present invention be so restricted.

What is claimed is:

1. A computer I/O switching means based on network links, comprising a central switch, and multiple bridges, wherein
the central switch includes a controller and at least one set of signal I/O interface with different signal specifications, and a network interface, wherein the set of signal I/O interface is to be linked to various I/O devices; and
bridges each comprise a controller, a set of I/O interface, and a network interface; wherein each I/O interface is to be linked to corresponding I/O port on a host computer; and the network interface is used for interconnecting other network components such as the controller of the central switch through a network link, wherein
the controller of the central switch allows for bi-directional communication with the counterparts in the bridges by means of network packets.

2. The computer I/O switching means based on network links as claimed in claim 1, wherein the controller of the central switch further includes a menu-based control program allowing users to choose a specific bridge for establishing system I/O; the controller also interacts with multiple I/O interface in a digital manner allowing compatible I/O devices to establish connection; and the network interface is connected to the controller for receiving or transmitting network packets over a network link.

3. The computer I/O switching means based on network links as claimed in claim 1, wherein the bridge further includes:
a network interface connected to the controller for sending network packets through a network link; and
a set of I/O interface respectively connected to corresponding I/O ports on a host computer, allowing for digital communication between the I/O interface and the controller.

4. The computer I/O switching means based on network links as claimed in claim 2, wherein the bridge further includes:
a network interface connected to the controller for sending network packets through a network link; and
a set of I/O interface respectively connected to corresponding I/O ports on a host computer, allowing for digital communication between the I/O interface and the controller.

5. The computer I/O switching means based on network links as claimed in claim 1, wherein the I/O interface is for a compatible video display, mouse or keyboard.

6. The computer I/O switching means based on network links as claimed in claim 2, wherein the I/O interface is for a compatible video display, mouse or keyboard.

7. The computer I/O switching means based on network links as claimed in claim 2, wherein the menu-based control program stored in the controller can be output to a monitor screen.
